(19) United States
(12) Patent Application Publication
(10) Pub. No.: US 2022/0392666 A1
(43) Pub. Date: Dec. 8, 2022

(54) TWISTED PAIR CABLE CONSTRUCTION TO IMPROVE CROSSTALK PERFORMANCE

(71) Applicant: Leviton Manufacturing UK Limited, London (GB)

(72) Inventors: Christopher Murray Sproule, London (GB); Paul Richardson, London (GB)

(21) Appl. No.: 17/338,062

(22) Filed: Jun. 3, 2021

(51) Int. Cl. H01B 11/04

(52) U.S. Cl. CPC H01B 11/04

(57) ABSTRACT

A twisted pair data cable has an internal construction that introduces an additional lay length design variable and thus permits a greater range of lay scheme options. A four-pair data cable can comprise four twisted pairs and can be fabricated such that the twisted pairs are segregated into two groups that each comprise two twisted pairs. In addition to the individual conductor pair twists, each of the two groups of two twisted pairs can be twisted independently of one another, improving the cable's ability to reject both internal and alien crosstalk interference. The smaller circumferential distance of each group also allows each group to have a smaller minimum overall lay if desired, allowing for a greater range of design options when selecting a combination of individual pair and overall lay lengths that satisfy electrical specification requirements in terms of interference rejection, insertion loss, and propagation delay.

### TECHNICAL FIELD

The disclosed subject matter relates generally to data cabling.

### BACKGROUND

Many types of data cables, including category-rated cables or other types of networking cables, carry multiple twisted conductor pairs so that a plurality of data signals can be routed via a single cable. Although the twisting of each pair of conductors can reduce signal interference due to internal crosstalk between the pairs, the conductor pairs may still be susceptible to some degree of crosstalk due to their proximity to one another within the cable jacket. Moreover, high-density installations may experience alien crosstalk between cables that run in close proximity to one another, particularly when unshielded twisted pair (UTP) cables are used.

The above-described deficiencies of current data cables are merely intended to provide an overview of some of the problems of current technology and are not intended to be exhaustive. Other problems with the state of the art, and corresponding benefits of some of the various non-limiting embodiments described herein, may become further apparent upon review of the following detailed description.

### SUMMARY

The following presents a simplified summary of the disclosed subject matter in order to provide a basic understanding of some aspects of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

Various embodiments described herein provide a data cable design that offers a greater range of lay scheme options relative to conventional twisted pair cables, yielding a cable that can better mitigate the effects of internal and alien crosstalk while also satisfying signal propagation delay requirements. In one or more embodiments, the total set of twisted conductor pairs housed in the cable's jacket are segregated into two groups of twisted pairs, each group having at least two twisted conductor pairs. A dividing structure inside the jacket maintains physical separation between the resulting two groups of twisted pairs. In addition to the individual twistings applied to each twisted pair, each of the two groups of twisted pairs can be twisted together within the jacket, yielding two overall lay lengths which can be offset from one another to reduce the effects of crosstalk. In contrast to cable designs that only permit overall twisting of all enclosed twisted pairs as a single group, embodiments of the cable design described herein can permit two smaller subsets of the twisted conductor pairs to be twisted together independently of one another. The smaller cross-sectional diameters—and corresponding smaller circumferential distances—of the two twisted pair groups permits a smaller overall lay for the two groups relative to twisting all the pairs as a single group. These smaller overall lays can allow tighter twisting of the individual twisted pairs while keeping the total signal propagation distance within standards.

To the accomplishment of the foregoing and related ends, the disclosed subject matter, then, comprises one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the drawings. It will also be appreciated that the detailed description may include additional or alternative embodiments beyond those described in this summary.

### BRIEF DESCRIPTION OF DRAWINGS

FIG. 1 is a perspective view of an example category cable containing four twisted pairs of electrical conductors.

FIG. 2 is a cross-sectional view of the example category cable.

FIG. 3 is a view of the example category cable with the jacket omitted.

FIG. 4 is a model of an example conductor arrangement for a data cable that supports segregation of twisted pairs into quad units.

FIG. 5 is a perspective view of a cable having a conjoined construction for housing two quad units.

FIG. 6 is a perspective view of the cable having the conjoined construction with the sub-jackets omitted.

FIG. 7 is a perspective view of an example cable that houses four twisted pairs that are divided into two quad units comprising two twisted pairs each, in which the two quad units are separated by a dividing wall that divides the interior of the cable's jacket into two chambers.

FIG. 8 is a cross-sectional front view of the cable in which the two quad units are separated by the dividing wall.

FIG. 9 is a diagram that compares quad unit rotational diameters with the rotational diameter of another twisted pair of cable.

FIG. 10 is a cross-sectional front view of an example cable that permits twisting of two quad units as well as a tertiary twisting of both quad units as a group.

FIG. 11 is a model illustrating an additional tertiary twist permitted by the cable that permits tertiary twisting of two quad units.

FIG. 12 is a flowchart of an example methodology for constructing a data cable that segregates twisted conductor pairs into two groups that can be independently twisted within the cable jacket.

### DETAILED DESCRIPTION

The subject disclosure is now described with reference to the drawings wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

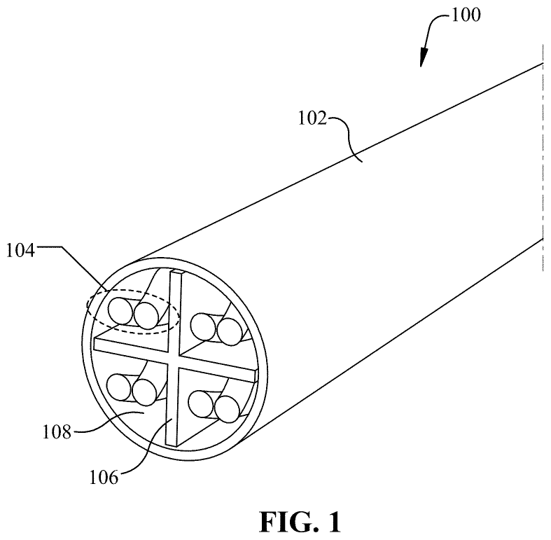

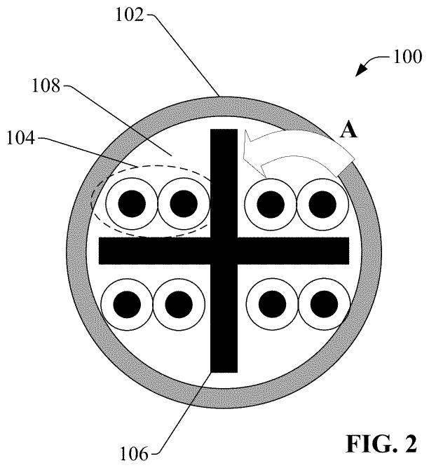

FIG. 1 is a perspective view of an example category cable 100 (e.g., CAT6A UTP cable) containing four twisted pairs 104 of electrical conductors. FIG. 2 is a cross-sectional view of cable 100. The jacket 102 of cable 100 houses the four twisted pairs 104 as well as an elongated flexible cross member 106 that extends through the length of the cable 100. The cross member 106 and the jacket 102 together define four cross-sectional quadrants 108, with each quadrant 108 containing one of the four twisted pairs 104. Cross member 106 maintains physical separation between the four twisted pairs 104.

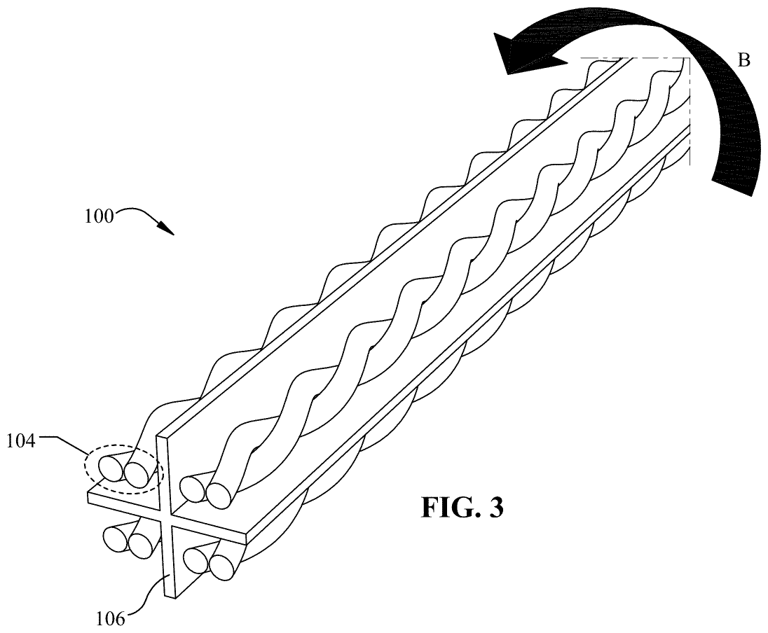

The twist rate, or pitch, of each twisted pair 104 determines that pair's individual lay length. The lay length of a given conductor is the distance required for the conductor to complete one revolution about the axis of its twisted pair 104, and is therefore a function of the twist rate of the pair 104. FIG. 3 is a view of cable 100 with the jacket 102 omitted so that the twistings of the individual twisted pairs 104 can be seen. The twist rate—and thus the lay length—of each of the twisted pairs 104 can be individually controlled during the cable manufacturing process. The twisting of an individual twisted pair 104 is referred to herein as twist A, represented by the arrow in FIG. 2. The effects of internal crosstalk between the twisted pairs 104 can be reduced by varying or offsetting the lay length between pairs 104; e.g., by varying the twist rate between the individual twisted pairs 104.

In addition to allowing the twist rate of each individual twisted pair 104 to be controlled, the design of cable 100 also allows the four twisted pairs 104 and the flexible cross member 106 to be twisted as a group about the axis of the cable 100. This twisting is referred to herein as twist B and is represented by the arrow in FIG. 3 (note that FIG. 3, while depicting the individual twistings of the twisted pairs 104, omits the overall twisting of the cross member 106 and twisted pairs 104 for clarity). Twist B yields an overall lay length for the collective group of four twisted pairs 104. This overall lay length is defined as the distance required for a given twisted pair 104 to complete one revolution about the axis of the cross member 106. The cross member 106 is made of a flexible material to allow the cross member 106 to be twisted, thereby achieve this overall lay.

The construction of cable 100 permits a number of design variables that affect the distances of the signal paths; namely, the individual lay lengths of the twisted pairs 104 (controlled by the pitch of twist A for each pair 104) and one overall lay length achieved by rotating the twisted pairs 104 and flexible cross member 106 about the axis of the cable 100. This overall lay length is determined by the pitch of twist B. These design variables can be set such that the electrical characteristics of the cable 100 satisfy safety and performance specifications. For example, in high density installations the proximity of cables 100 to one another can produce interference due to alien crosstalk between the cables 100. The effects of alien crosstalk can be reduced by making the lay lengths of the twisted pairs 104 tight and consistent. However, if an individual twisted pair 104 is twisted too tightly its electrical characteristics may deviate from specification requirements due to the corresponding increase of the total signal propagation distance, which must be kept below a maximum signal path distance in some use cases.

To address these and other issues, one or more embodiments described herein provide a data cable having an internal construction that introduces an additional lay length design variable and thus permits a greater range of lay scheme options. In one or more embodiments, a data cable comprising four twisted pairs 104 can be fabricated such that the twisted pairs 104 are segregated into two groups—referred to herein as quad units—that each comprise two twisted pairs 104. In addition to the individual conductor pair twists (twist A), each of the two groups of two twisted pairs 104 can be twisted independently of one another, improving the cable's ability to reject both internal and alien crosstalk interference. The smaller circumferential distance of each quad unit relative to that of overall twist B described above also allows each quad unit to have a smaller minimum overall lay if desired (approximately half the minimum lay length achieved by twist B), allowing for a greater range of design options when selecting a combination of individual pair and overall lay lengths that satisfy electrical specification requirements in terms of interference rejection, insertion loss, and propagation delay.

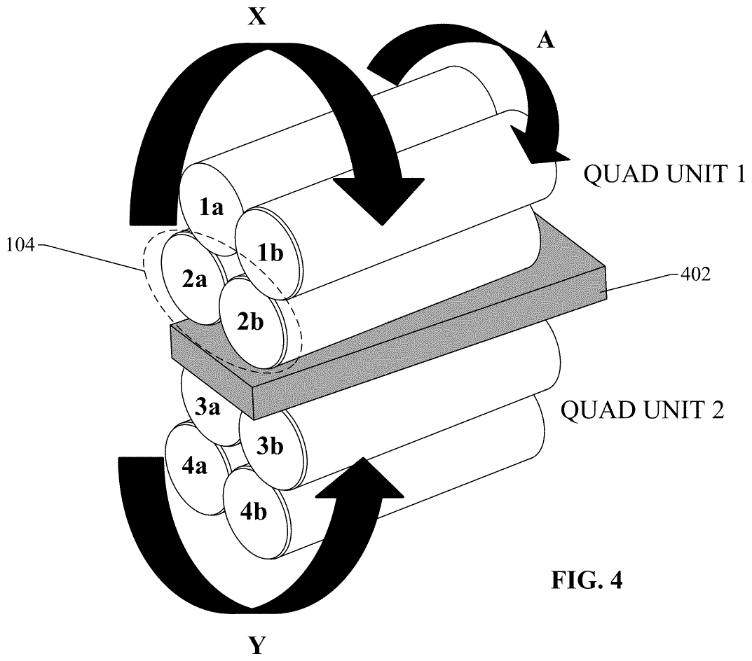

FIG. 4 is a model of an example conductor arrangement for a data cable that supports segregation of twisted pairs 104 into quad units according to one or more embodiments. In this example, the cable comprises four twisted pairs 104, including a first pair comprising conductors 1a and 1b, a second pair comprising conductors 2a and 2b, a third pair comprising conductors 3a and 3b, and a fourth pair comprising conductors 4a and 4b. These four twisted pairs 104 are segregated into two groups of two pairs 104 per group. A first group (quad unit 1) comprises the 1a-1b pair and the 2a-2b pair, while a second group (quad unit 2) comprises the 3a-3b pair and the 4a-4b pair. The two quad units are physically separated by a dividing member 402, which can have different constructions in various embodiments as will be discussed in more detail herein.

Each twisted pair 104 can be twisted individually as represented in FIG. 4 by twist A for the 1a-1b twisted pair. In addition, each quad unit as a whole can be twisted independently of one another, such that the two pairs 104 that make up each quad unit are twisted together as a group. As illustrated in FIG. 4, twist X represents the twisting of quad unit 1, and twist Y represents the twisting of quad unit 2. Thus, as an alternative to twisting all four twisted pairs 104 together as a group about the cable axis (via twist B in FIG. 3) to achieve a single overall lay, the construction illustrated in FIG. 4 permits two smaller groupings of two twisted pairs 104 to be twisted, resulting in two overall lays for the respective two quad units.

Since each quad unit can be twisted independently of one another, the cable can be manufactured such that twist X has a different pitch than twist Y, yielding two different lay lengths for the two quad units. In this regard, the two quad units can be considered two differing cables within the same cable jacket, each having a different overall lay length determined by the pitch of their respective group twists X and Y. This yields an additional design variable relative to cable 100, since the overall twist B of cable 100 is replaced with two smaller twists X and Y for the two quad units, each having a pitch that can be set independently of the other. This construction allows the electrical characteristics of each quad unit to be set independently of one another using different combinations of pitches for the individual twists A and group twists X or Y for each quad unit, allowing for a greater range of lay scheme options.

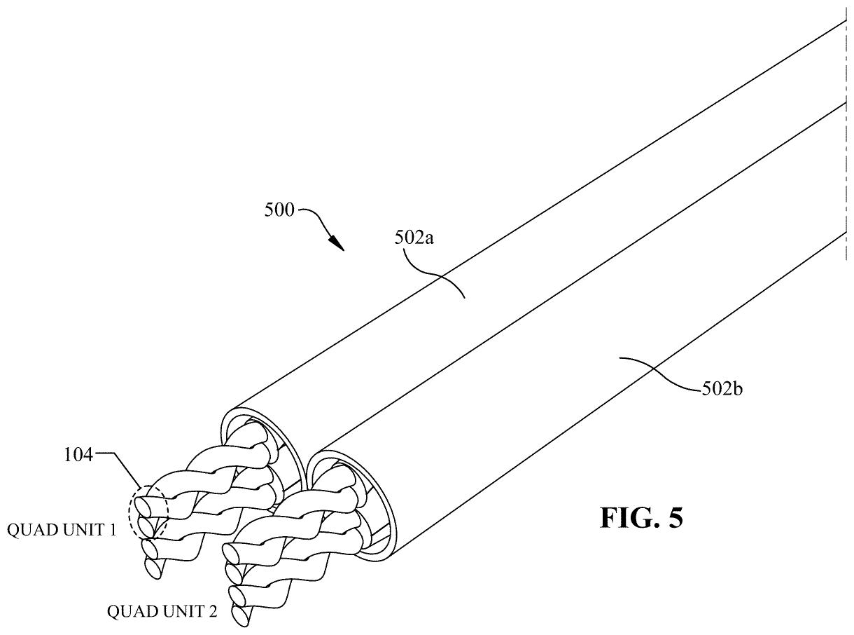

Different jacket designs can be used to house the twisted pairs 104 in a manner that allows the two quad units to be individually twisted as illustrated in FIG. 4. For example, FIG. 5 is a perspective view of a cable 502 having a conjoined construction for housing the two quad units. In this embodiment, the cable jacket comprises two sub-jackets 502a and 502b having circular cross-sections, with the two sub-jackets 502a and 502b joined together by a seam of jacket material. Each sub-jacket 502a and 502b houses one of the two quad units (two twisted pairs 104 per sub-jacket 502a and 502b).

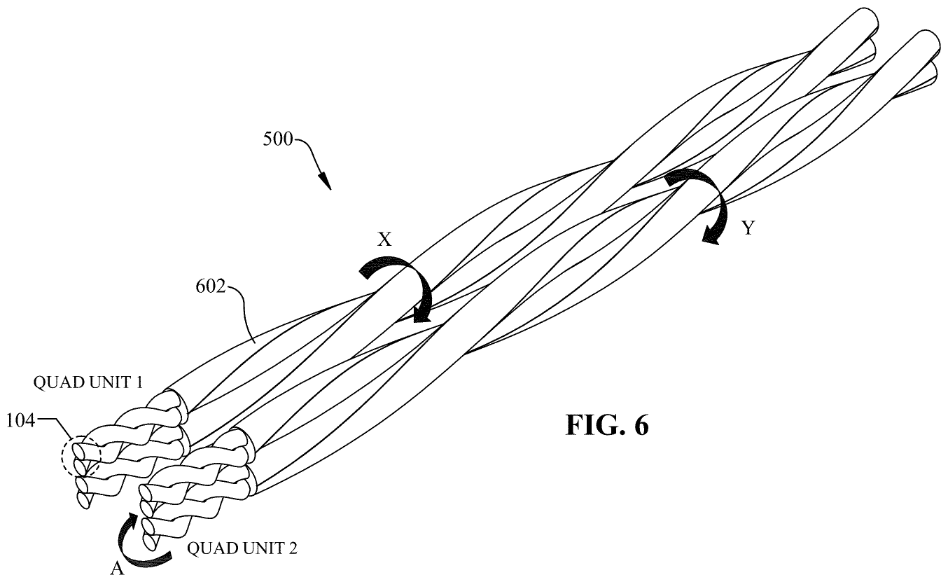

FIG. 6 is a perspective view of the cable 500 with the sub-jackets 502a and 502b omitted so that the twisted pairs 104 can be viewed. As shown in this view, in addition to the individual twists A applied to each twisted pair 104, each of the two quad units—comprising two twisted pairs 104 each—is twisted as a group (twists X and Y), as described above in connection with FIG. 4. In some embodiments, each twisted pair 104 can also be housed in an individual jacket of insulation 602, as shown in FIG. 6.

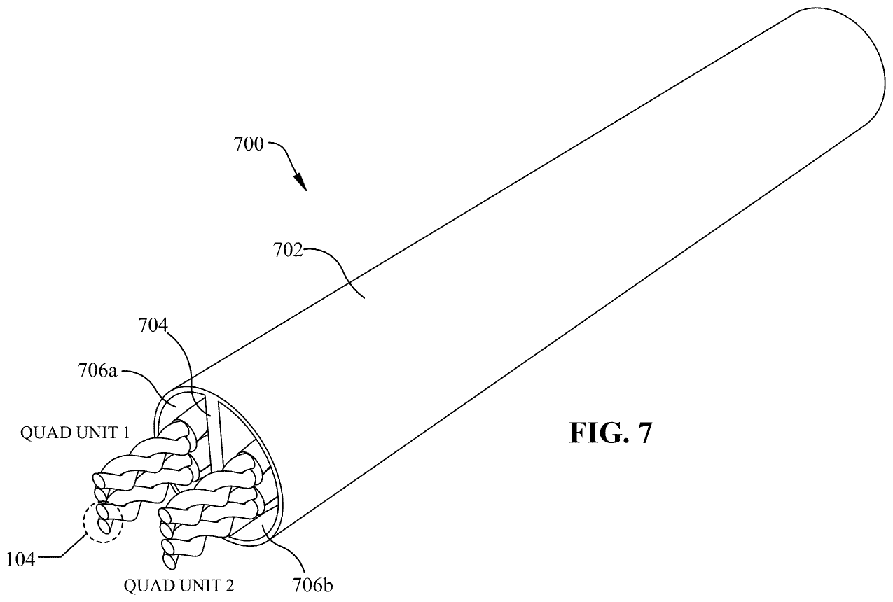

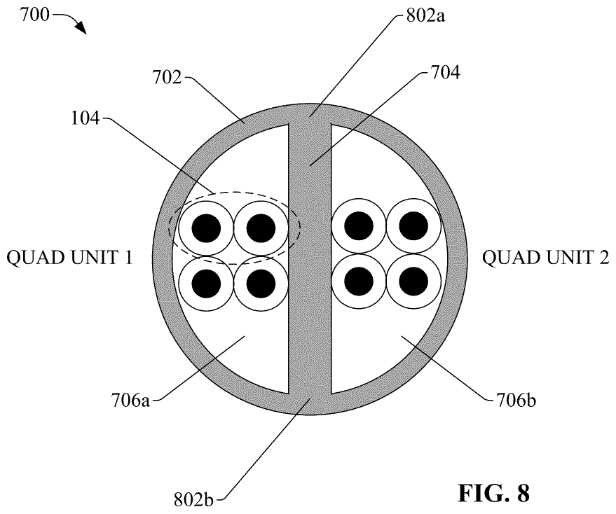

In the conjoined configuration illustrated in FIG. 5, the material of sub-jackets 502a and 502b as well as the connective material that joins the two sub-jackets 502a and 502b serve as the dividing member 402 (see FIG. 4) between the two quad units. In another example embodiment, the dividing member 402 can instead comprise a flat web of jacket material that separates the quad units within a single jacket. FIG. 7 is a perspective view of an example cable 700 that houses four twisted pairs 104 that are divided into two quad units comprising two twisted pairs 104 each, in which the two quad units are separated by a dividing wall 704 that divides the interior of the cable's jacket 702 into two chambers 706a and 706b. FIG. 8 is a cross-sectional front view of the cable 700. In this example, the jacket 702 has a circular cross-section and includes a dividing wall 704 that extends through the length of the cable 700. The dividing wall 704 comprises a flat layer of material having a width that traverses a diameter of the circular cross-sectional profile of the jacket 702. Two opposing lengthwise edges of the dividing wall 704 are anchored to the interior surface of the jacket 702 at opposing locations 802a and 802b of the jacket's cross-section. Thus, the dividing wall 704 bisects the circular profile of the jacket 702 to yield two segregated chambers 706a and 706b, each of which houses one of the two quad units (two twisted pairs 104 per chamber). The dividing wall 704 prevents compression of the two quad units against one another, and in some embodiments can also maintain a circular, rather than oval, jacket formation.

The construction of cable 700 permits the same twisting options (twists A, X, and Y) illustrated in FIGS. 4 and 6 but, in contrast to cable 500, houses the two quad units within a single uniform circular jacket 702 rather than two smaller sub-jackets 502a and 502b. Each quad unit can be twisted within its corresponding chamber 706a, 706b to achieve twists X and Y.

Although only two example cables 500 and 700 that support independent twisting of quad units have been illustrated, other cable constructions capable of segregating a set of twisted pairs 104 into two smaller groups that can be twisted independently of one another are also within the scope of one or more embodiments.

The constructions of cables 500 and 700 offer a number of advantages relative to conventional twisted pair cables (such as cable 100). For example, the introduction of twists X and Y allows the two quad units—that is, the two sets of two pairs 104—to be treated as individual units whose electrical characteristics can be set independently of one another. In addition to allowing the pitch of each twist A to be set independently for each individual twisted pair 104, the pitches of twists X and Y for each group of two twisted pairs 104 can also be set independently of one another, allowing the twist rates of the two quad units to be offset from one another. Differentiating the pitches of twists X and Y can improve the electrical performance of the cables 500 and 700 by further reducing the effects of both internal crosstalk and alien crosstalk even if no shielding is used.

The additional design variables afforded by segregating the four twisted pairs 104 into two independent groups also permits a greater range of lay scheme options. For example, rather than manufacturing cable 500 or 700 such that the twist pitches of the individual twisted pairs 104 are offset from one another to a large degree in order to reduce the effects of internal crosstalk, the twists A of the individual twisted pairs 104 can be made to have equal or similar pitches to one another, while the pitches of twists X and Y for the two quad units can be offset to mitigate internal crosstalk, resulting in two different overall lays for the two quad units. This can simplify the problem of mitigating the effects of internal crosstalk by eliminating the need to introduce offsets between the lay lengths of individual twisted pairs 104.

In another example configuration, the individual twist A for one or more of the twisted pairs 104 can be made tighter to better reject crosstalk interference, resulting in a small individual pair lay, and this short individual pair lay can be compensated for using a longer overall lay for the quad unit in which the twisted pair 104 resides by using a long pitch for twist X or Y. Selecting a suitable combination of pitches for twists A and X or Y can yield a cable 500 or 700 that satisfies a maximum signal path requirement even if relatively tight individual pair twists A are introduced. That is, short lay lengths at either the individual pair level or the overall quad unit level can be compensated for by longer lay lengths at the other level.

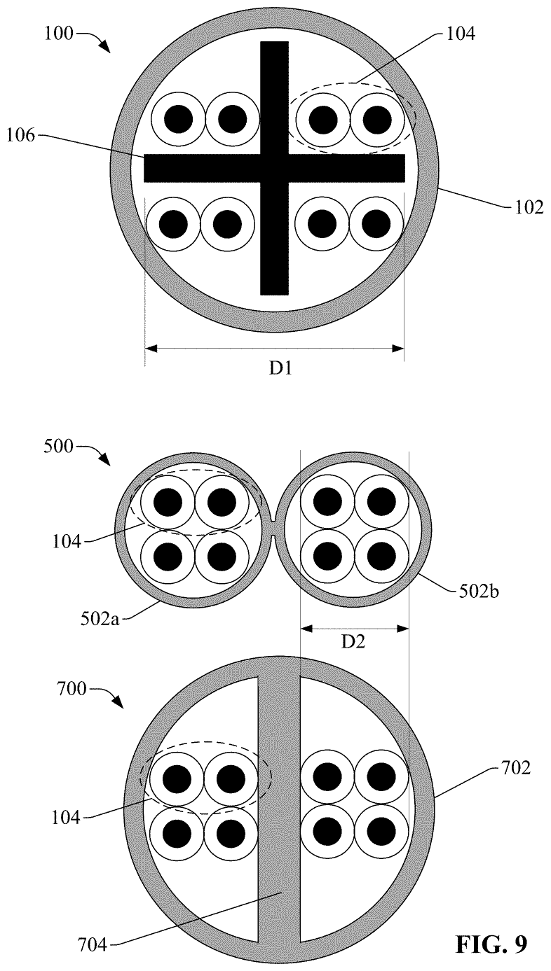

Also, since the diameter of each quad unit is smaller than the diameter of the larger grouping of four twisted pairs 104, dividing the four twisted pairs 104 into two quad units reduces the helical distance of the resulting quad unit lays relative to the overall lays of conventional cables (e.g., cable 100). FIG. 9 is a diagram that compares the quad unit rotational diameters D2 of cables 500 and 700 with the rotational diameter D1 of the twisted pairs of cable 100. As shown in this figure, diameter D1 is the diameter of the rotation required to twist the four twisted pairs 104, together with cross member 106, about the axis of cable 100 to produce the overall lay (twist B of FIG. 3). The size of diameter D1 is partly a function of the physical separation between the twisted pairs 104 by the cross member 106 and the necessity to twist all four twisted pairs 104 as a collective unit. By contrast, each quad unit of cables 500 and 700 has a smaller rotational diameter D2, since this diameter is based on only four twisted pairs 104 that are compressed together. Since the circumferential distance traveled by a conductor of a twisted pair 104 to complete one twist rotation is a function of these diameters (according to C=π*D, where C is the circumferential distance and D is the rotational diameter), the circumferential distance of each quad unit is smaller than that of cable 100 as a whole. This allows each quad unit to achieve a smaller overall lay relative to that of cable 100.

The smaller overall lay of the quad units can offer a greater range of design options relative to cable 100. For example, for a given individual lay length for the twisted pairs 104, the overall lay length can be reduced to approximately half that of cable 100 while maintaining the same propagation delay and insertion loss. In another design example, if an overall lay length for a quad unit is made equal to that of a given cable 100, the individual lay lengths for the twisted pairs 104 can be reduced relative to those of cable 100 while maintaining the same propagation delay and insertion loss. This can further mitigate the effects of crosstalk interference by allowing tighter twisting on the individual twisted pairs 104 while maintaining the same overall signal propagation distance. Reducing the diameter from D1 to D2 allows the lay lengths of the individual twisted pairs 104 to be reduced while maintaining the same signal distance if desired, since the total distance that each conductor must travel to complete one rotation of the overall twist is reduced relative to the design of cable 100. In general, segregating the four twisted pairs 104 into two quad units that can be twisted independently within the same cable jacket effectively doubles the overall lay length options relative to cable 100, while also permitting offsets to be introduced between the twist pitches of the two resulting quad units.

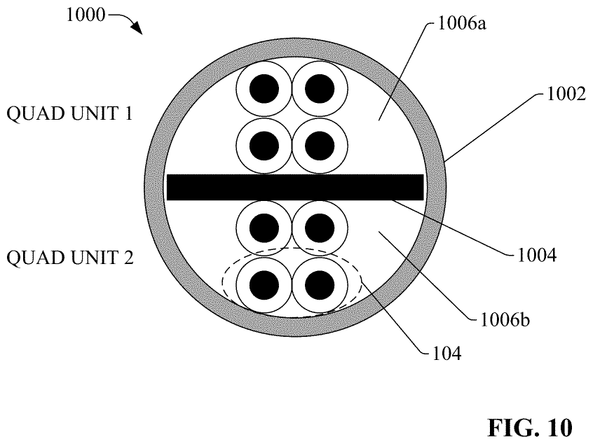

According to another embodiment, the design of cable 700 can be modified to permit a tertiary twisting of the conductors in addition to the individual twists A and the quad unit twists X and Y. FIG. 10 is a cross-sectional front view of another example cable 1000 that permits twisting of the two quad units as well as a tertiary twisting of both quad units as a group. In this example, the four twisted pairs 104 are housed inside a jacket 1002 having a circular cross-sectional profile and are grouped into two quad units, similar to cables 500 and 700. In contrast to cable 700, which maintains physical separation between the two quad units using a dividing wall 704 that is anchored to the interior surface of jacket 702 along two edges, cable 1000 maintains separation between the two quad units using a flat cross-member centerpiece 1004 that is not anchored to the interior surface of the cable's jacket 1002. Centerpiece 1004 is a flat strip of flexible material that is housed inside the jacket 1002, and which traverses the length of the cable 1000. The width of the centerpiece 1004 is slightly smaller than the interior diameter of jacket 1002, ensuring that the centerpiece 1004 resides at a location that approximately bisects the circular cross-section of the jacket 1002 while permitting the centerpiece 1004 to rotate within the jacket 1002 about the axis of the cable 1000. The centerpiece 1004 thus divides the interior of the jacket 1002 into two chambers 1006a and 1006b, each of which houses one of the two quad units.

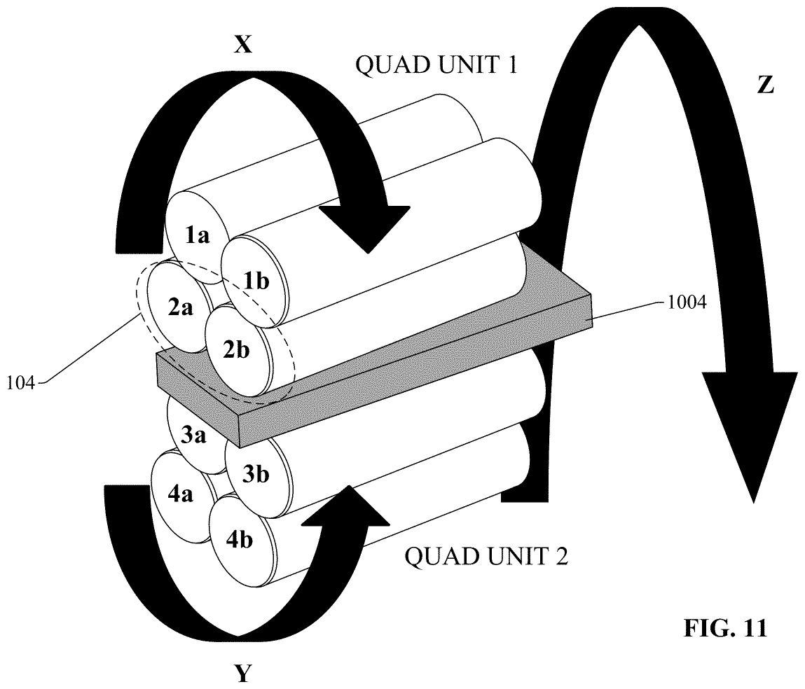

FIG. 11 is a model illustrating the additional tertiary twist permitted by this arrangement. In addition to permitting twisting of the individual twisted pairs (twists A, omitted from FIG. 11 for clarity) and independent twisting of the two quad units (twists X and Y), cable 1000 also permits a tertiary twist Z whereby the two quad units and the centerpiece 1004 are twisted as a group within the jacket 1002. Introduction of tertiary twist Z can further mitigate alien crosstalk interference, particularly in high density installations in which cables reside in close proximity to one another.

Although examples described herein have considered cables that comprise four total twisted pairs 104 that are divided into two smaller quad unit groupings of two pairs per groups, this cable design principle can also be applied to cables having greater numbers of twisted pairs 104 without departing from the scope of this disclosure. For example, a six-pair cable can be designed such that the six twisted pairs are divided into two groups of three pairs per group, such that the resulting to groups of three twisted pairs can be twisted independently of one another within the cable jacket.

Embodiments of the data cable constructions described herein can offer cable designers greater flexibility with regard to cable lay options by introducing an additional design variable and by dividing the overall twist diameter D1 into two smaller twist diameters D2. The cable lay options afforded by these constructions can improve the cable's ability to reject interference due to internal and alien crosstalk even if no shielding is used (e.g., in unshielded twisted pair, or UTP, embodiments).

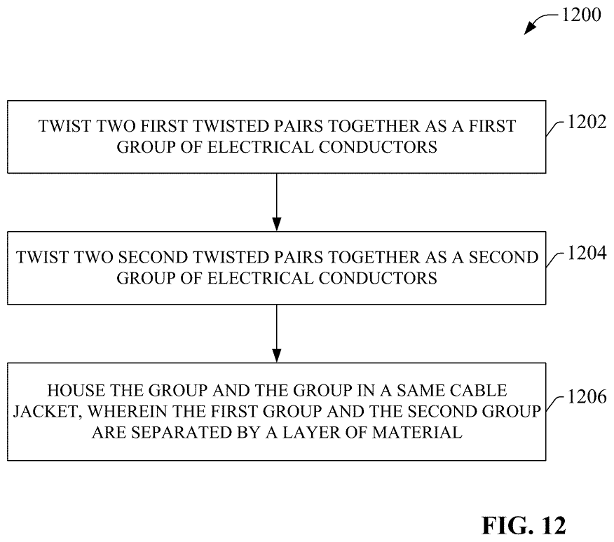

FIG. 12 illustrates a methodology in accordance with one or more embodiments of the subject application. While, for purposes of simplicity of explanation, the methodology shown herein are described as a series of steps, it is to be understood and appreciated that the subject innovation is not limited by the order of steps, as some steps may, in accordance therewith, occur in a different order and/or concurrently with other steps from that shown and described herein. For example, those skilled in the art will understand and appreciate that a methodology could alternatively be represented as a series of interrelated states or events, such as in a state diagram. Moreover, not all illustrated steps may be required to implement a methodology in accordance with the innovation. Furthermore, interaction diagram(s) may represent methodologies, or methods, in accordance with the subject disclosure when disparate entities enact disparate portions of the methodologies. Further yet, two or more of the disclosed example methods can be implemented in combination with each other, to accomplish one or more features or advantages described herein.

FIG. 12 illustrates an example methodology 1200 for constructing a data cable that segregates twisted conductor pairs into two groups that can be independently twisted within the cable jacket. Although methodology 1200 assumes a four-pair cable, the construction principle can also be applied to data cables having greater numbers of twisted pairs. Initially, at 1202, two first twisted pairs are twisted together as a first group of electrical conductors. At 1204, two second twisted pairs are twisted together as a second group of electrical conductors. At 1206, the first group created at step 1202 and the second group created at step 1204 are housed in a same cable jacket, such that the first group and the second group are separated by a layer of material (e.g., a dividing wall 704 as in cable 700, or a centerpiece 1004 as in cable 1000).

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

What has been described above includes examples of systems and methods illustrative of the disclosed subject matter. It is, of course, not possible to describe every combination of components or methodologies here. One of ordinary skill in the art may recognize that many further combinations and permutations of the claimed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

1. A data cable, comprising:
a set of twisted pairs of electrical conductors housed inside a jacket,
wherein
the set of twisted pairs is segregated into a first group comprising a first subset of the twisted pairs that are twisted together and a second group comprising a second subset of the twisted pairs that are twisted together,
the jacket comprises a dividing wall that extends along a length of the jacket and that is anchored to an interior surface of the jacket along its lengthwise edges, and
the first group is separated from the second group by the dividing wall.

2. The data cable of claim 1, wherein the first group and the second group respectively comprise at least two twisted pairs of the set of twisted pairs.

3. The data cable of claim 1, wherein
the first subset of the twisted pairs are twisted together at a first twist rate,
the second subset of the twisted pairs are twisted together at a second twist rate, and
the first twist rate is different than the second twist rate.

4. The data cable of claim 1, wherein at least a first twisted pair of the set of twisted pairs is twisted at a rate that is different from at least a second twisted pair of the set of twisted pairs.

5. The data cable of claim 1, wherein
the two chambers house the first group and the second group, respectively.

6. (canceled)

7. The data cable of claim 1, wherein the data cable is an unshielded twisted pair cable.

8. The data cable of claim 1, wherein the jacket comprises a circular or substantially circular cross-sectional profile.

9. The data cable of claim 1, wherein respective twist diameters of the first subset of the twisted pairs and the second subset of the twisted pairs are smaller than a twist diameter of the set of twisted pairs.

10. A cable, comprising:
a jacket having a dividing wall that extends along a length of the jacket to form two chambers within the jacket, wherein the dividing wall is anchored to an interior surface of the jacket along its lengthwise edges;
a first set of twisted conductor pairs housed inside a first of the two chambers and twisted together as a first group; and
a second set of twisted conductor pairs housed inside a second of the two chambers and twisted together as a second group.

11. The cable of claim 10, wherein
individual twisted conductor pairs of the first set and the second set have individual lay lengths determined by respective individual twist pitches applied to the individual twisted conductor pairs, and
the first group and the second group have respective overall lay lengths determined by group twist pitches applied to the first group and the second group, respectively.

12. The cable of claim 11, wherein a first overall lay length of the first group is different than a second overall lay length of the second group.

13. The cable of claim 11, wherein a first individual lay length of a first of the twisted conductor pairs is different than a second individual lay length of a second of the twisted conductor pairs.

14. The cable of claim 10, wherein the first set of twisted pair conductors and the second set of twisted pair conductors respectively comprise at least two twisted pair conductors.

15. (canceled)

16. (canceled)

17. The cable of claim 10, wherein the cable is an unshielded twisted pair cable.

18. The cable of claim 10, wherein the jacket has a cross-sectional profile that is circular or substantially circular.

19. A method, comprising:
twisting two or more first twisted conductor pairs together as a first group of electrical conductors;
twisting two or more second twisted conductor pairs together as a second group of electrical conductors; and
installing the first group and the second group in a cable jacket comprising a dividing wall that is integrated with, and extends along a length of, the jacket to form two chambers within the jacket, wherein the installing comprises installing the first group in a first of the two chambers and installing the second group in a second of the two chambers.

20. The method of claim 19, wherein
the twisting of the two or more first twisted conductor pairs comprises twisting the two or more first twisted conductor pairs according to a first pitch,
the twisting of the two or more second twisted conductor pairs comprises twisting the two or more second twisted conductor pairs according to a second pitch, and
the first pitch is different than the second pitch.

21. The method of claim 19, further comprising twisting at least a first of the two or more first twisted conductor pairs at a rate that is different from at least a second of the two or more first twisted conductor pairs.

22. The method of claim 19, wherein the cable jacket comprises a circular or substantially circular cross-sectional profile.

23. The method of claim 19, wherein the twisting of the two or more first twisted conductor pairs and the twisting of the two or more second twisted conductor pairs yields respective twist diameters for the first group of electrical conductors and the second group of electrical conductors that are smaller a twist diameter of the collective group.
